(19) United States
(12) Patent Application Publication
(10) Pub. No.: US 2026/0367594 A1
(43) Pub. Date: Nov. 19, 2026

(54) Method for Predicting a Control Action for a Technical System

(71) Applicant: Robert Bosch GmbH, Stuttgart (DE)

(72) Inventors: Louis Bergmann, Stuttgart (DE); Hendrik Berkemeyer, Ludwigsburg (DE); Jens Stefan Buchner, Bietigheim-Bissingen (DE)

(21) Appl. No.: 19/673,293

(22) Filed: May 11, 2026

(30) Foreign Application Priority Data
May 13, 2025 (DE) 10 2025 118 353.8

(51) Int. Cl. G05B 13/04; G05B 13/02

(52) U.S. Cl. CPC G05B 13/048; G05B 13/0265

(57) ABSTRACT

A method for predicting a control action for a technical system disclosed. Furthermore, a computer program, a device, and a storage medium for this purpose is also disclosed.

### CROSS-REFERENCE TO RELATED APPLICATIONS

This application claims priority under 35 U.S.C. § 119 to patent application no. DE 10 2025 118 353.8, filed on May 13, 2025 in Germany, the disclosure of which is incorporated herein by reference in its entirety.

The disclosure relates to a method for predicting a control action for a technical system. Furthermore, the disclosure relates to a computer program, a device, and a storage medium for this purpose.

### BACKGROUND

In the area of autonomous driving and general robotics, Vision Language Models (VLM), or Vision Language Action Models (VLA) or Foundation Models (FM) are currently used primarily for static environmental perception. Current systems use these models to interpret sensor data, such as camera images, to detect objects and assess situations. However, these approaches are often limited to pre-trained models that do not allow for continuous adaptation or learning, for example while driving.

Existing systems do not update their assumptions about the environment in real time and do not have mechanisms to learn from past errors or unexpected events and to verify alternative solutions. In addition, unexpected situations are often not effectively used to improve the system for future similar events. There is a lack of an approach that both ensures real-time performance and enables continuous improvement of the assumptions by learning from past experiences.

### SUMMARY

The subject matter of the disclosure is a method, a computer program, a device, and a computer-readable storage medium having the features set forth below. Further features and details of the disclosure result from the description and the drawings. Features and details described in connection with the method according to the disclosure likewise, as a matter of course, apply in connection with the computer program according to the disclosure, the device according to the disclosure, and the computer-readable storage medium according to the disclosure, and vice versa, such that a mutual reference is always possible with respect to the disclosure of the disclosure.

The subject matter of the disclosure is, in particular, a method for predicting a control action for a technical system, for example a vehicle or a robot, comprising:
providing sensor data, in particular image data, wherein the sensor data results from an acquisition by at least one sensor, in particular a camera sensor, of the technical system,
predicting at least one assumption regarding an environment of the technical system based on an analysis of the provided sensor data by way of a first vision language model, in particular by way of a classification and a subsequent interpretation of a result of the classification,
providing further sensor data, wherein the further sensor data results from a further acquisition by the at least one sensor of the technical system, wherein the acquisition of the further sensor data is preferably performed after the acquisition of the sensor data, more preferably at a time for which the at least one assumption was predicted,
verifying the at least one predicted assumption based on an analysis of the provided further sensor data, wherein it is in particular verified whether the at least one predicted assumption has actually occurred or actually corresponds to reality,
wherein, in the event that a result of the verification indicates that the at least one predicted assumption is false, the following further steps are performed:
   determining at least one new assumption regarding the environment of the technical system based on an analysis of the provided sensor data and/or the provided further sensor data and the result of the verification by way of a second vision language model, wherein the second vision language model, in particular, performs a classification based on the provided sensor data and/or the provided further sensor data and subsequently interprets a result of the classification while taking into account the result of the verification, wherein the second vision language model can be executed on an external data processing device, wherein, in this case, first transmitting the corresponding data, i.e., the provided sensor data and/or the provided further sensor data and the result of the verification, to this external data processing device can be provided,
   predicting the control action for the technical system using the at least one new assumption by way of the first vision language model.

Furthermore, the additional step may be provided that execution of the predicted control action for the technical system is initiated. The method according to the disclosure may achieve the advantage that the accuracy of controlling the technical system may be increased and the response to changes in the environment may be improved. By employing multiple vision language models, rapid decision-making for real-time requirements can be ensured while allowing a more comprehensive understanding of the environment through the second vision language model. This iterative analysis allows for continuous adaptation and improvement of the assumptions, resulting in a more robust and reliable technical system.

It is further advantageous if, within the scope of the disclosure, the at least one assumption represents at least one visible and/or deducible condition regarding the environment, in particular a structural nature, a positioning or movement of objects and/or a weather condition, and/or at least one visible and/or deducible condition regarding at least one person, in particular a traffic participant, in the environment of the technical system, in particular an intention or prospective movement of the at least one person. This provides the advantage that extensive assumptions about the environment can be predicted, thereby enabling precise decision-making and guidance of the technical system. Considering visible and deducible conditions such as structural characteristics, object positions, weather conditions, or human intentions allows for a comprehensive situational analysis and can contribute to the safety and efficiency of the technical system.

Additionally, it may be provided that the second vision language model is more powerful than the first vision language model, and that the second vision language model is executed at a lower frequency than the first vision language model. As a result, resources can be utilized more efficiently because the more powerful second vision language model is only used as needed, and processing for less complex tasks is not unnecessarily burdened. For example, the first vision language model may be executed on a data processing device that may have less computational power. For example, the second vision language model may be executed on an external data processing device, in which higher computing power is available. This particularly allows the technical system to respond in real time while also performing in-depth analyses to improve the accuracy of the predicted assumptions. A requirement for the real-time execution of the overall system is, in particular, the coupling of the various models with sufficiently low latency (i.e., the cumulative latency should preferably not violate the real-time condition) and the reliability of the connection.

Preferably, it may be provided within the scope of the disclosure that the method, in the event that the result of the verification indicates that the at least one predicted assumption is false, further comprises:
initiating a transition of the technical system to a safe state, in particular by way of a braking operation.

This will result in the technical system automatically taking action in the event of false assumptions to ensure safe operation while allowing more time for the second vision language model. This may advantageously increase the safety of the technical system, especially in critical situations.

Additionally, it may be provided that the method, in the event that the result of the verification indicates that the at least one predicted assumption is false, further comprises:
providing training data based on the provided sensor data, the provided further sensor data, and the result of the verification, and preferably further based on the at least one new assumption.

As a result, the technical system may be continuously improved by learning from mistakes. The use of training data based on the predicted assumptions, the actual events, and the discrepancies allows for adjustment of the technical system and/or the vision language models of the technical system to new situations and challenges. This may result in higher accuracy of predictions and improved performance.

Furthermore, it may be provided that the method, in the event that, during the determination of the at least one new assumption, an error occurs or no new assumption can be determined, further comprises at least one of the following steps: determining at least one new assumption regarding the environment of the technical system based on an analysis of the provided sensor data and/or the provided further sensor data and the result of the verification by way of a third vision language model, wherein the third vision language model is more powerful than the second vision language model, initiating output of a notification to a human operator.

This has the advantage that the technical system can rely on a more powerful third vision language model in cases of errors or inability of the second vision language model to generate a new assumption. This increases functional safety. Additionally, by notifying the human operator, early intervention may be achieved in complex situations, thereby increasing the safety of the technical system.

It is also optionally conceivable that the method further comprises:
providing data from at least one external data source, wherein the data comprises traffic information relating to the environment of the technical system and/or map data relating to the environment of the technical system,
wherein the prediction of the at least one assumption, the verification, and/or the determination is further performed based on the provided data from the at least one external data source. Thus, the technical system can improve its accuracy and decision-making by integrating data from external data sources such as traffic or map data. Consideration of data such as traffic flow, signage, and geographic information can expand an information base for the vision language models, thereby enabling more precise predictions.

It is possible for the method according to the disclosure to be used in a vehicle. The vehicle can be designed, for example, as a motor vehicle and/or passenger vehicle and/or at least partially automated/autonomous vehicle. The vehicle may comprise a vehicle device, for example, for providing an autonomous driving function and/or a driver assistance system. The vehicle device may be configured to at least partially automatically control and/or accelerate and/or decelerate and/or steer the vehicle.

The vision language model, i.e., in particular each of the vision language models described, was preferably trained for classification and, in particular, for object detection. The training may be provided to train the vision language model by way of a training data set for classification, in particular, for image classification, of image data such as digital images on the basis of image points and/or image pixels, in particular, pixel values, preferably edges or pixel attributes of the image data. The image data or digital images within the scope of training may result, for example, from a recording by at least one sensor, preferably at least one camera, more preferably of a vehicle, and most preferably of a camera and/or a vehicle environment during a journey of a vehicle. The recording is possible by at least one camera of the vehicle, for example. The classification may be provided to recognize objects in an environment imaged by the image data or digital images and/or to detect a traffic scene.

A classification result may comprise at least one of the following results and/or may be specific to at least one of the following results: a category of objects, an identification of objects, a location of objects and/or obstacles (e.g., in the direction of travel or adjacent to the direction of travel), a presence of obstacles, a description of a traffic scene, a hazard notification, a number of objects, a type and/or location of roadway markings and/or a roadway boundary, a location and/or a state of traffic signaling systems, a location of a roadway, a state of the roadway or the weather, a (future) behavior of a traffic participant or the like.

By way of the classification, for example, an obstacle may be recognized, irrespective of whether it lies directly in the driving direction or adjacent thereto. Depending on the localization (for example, in dependence on the expected vehicle trajectory), a corresponding control action such as deceleration or evasive action may be initiated.

Another object of the disclosure is a computer program, in particular a computer program product, comprising instructions which, when the computer program is executed by at least one computer, cause the computer to carry out the method according to the disclosure. The computer program according to the disclosure thus brings about the same advantages as have been described in detail with reference to the method according to the disclosure.

The subject matter of the disclosure is also a device for data processing that is configured to execute the method according to the disclosure. The device may be at least one computer, for example, that executes the computer program according to the disclosure. The computer may have at least one processor for executing the computer program. A non-volatile data memory may be provided as well, in which the computer program may be stored and from which the computer program may be read by the processor for execution.

The disclosure may also relate to a computer-readable storage medium, which comprises the computer program according to the disclosure and/or commands that, when executed by at least one computer, cause said computer to carry out the method according to the disclosure. The storage medium is configured, for example, as a data memory such as a hard disk and/or a non-volatile memory and/or a memory card. The storage medium may, for example, be integrated in the computer.

Furthermore, the method according to the disclosure may also be executed as a computer-implemented method. Alternatively or additionally, at least one of the disclosed method steps may be computer-implemented and/or performed automatically.

### BRIEF DESCRIPTION OF THE DRAWINGS

Further advantages, features and details of the disclosure will be apparent from the following description, in which exemplary embodiments of the disclosure are described in detail with reference to the drawings. In this case, the features mentioned in the claims and in the description may in each case be essential to the disclosure individually or in any desired combination. The figures show:

FIG. 1 a schematic visualization of a method, a device, a storage medium, and a computer program according to exemplary embodiments of the disclosure,

FIG. 2 a schematic illustration of a technical system according to exemplary embodiments of the disclosure.

### DETAILED DESCRIPTION

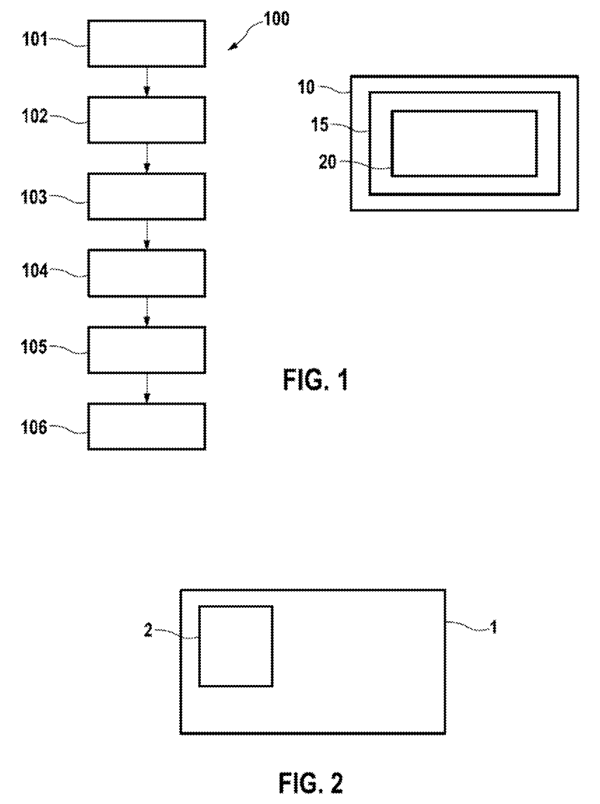

FIG. 1 schematically illustrates a method 100, a device 10, a storage medium 15, and a computer program 20 according to exemplary embodiments of the disclosure.

In particular, FIG. 1 shows an exemplary embodiment of a method 100 for predicting a control action for a technical system 1. In a first step 101, sensor data is provided, wherein the sensor data results from an acquisition by at least one sensor 2 of the technical system 1. In a second step 102, at least one assumption regarding an environment of the technical system 1 is predicted based on an analysis of the provided sensor data by way of a first vision language model. In a third step 103, further sensor data is provided, wherein the further sensor data results from a further acquisition by the at least one sensor 2 of the technical system 1. In a fourth step 104, the at least one predicted assumption is verified based on an analysis of the provided further sensor data. In the event that a result of the verification 104 indicates that the at least one predicted assumption is false, the following further steps are performed: In a fifth step 105, at least one new assumption regarding the environment of the technical system 1 is determined based on an analysis of the provided sensor data and/or the provided further sensor data and the result of the verification 104 by way of a second vision language model. In a sixth step 106, the control action for the technical system 1 is predicted using the at least one new assumption by way of the first vision language model.

FIG. 2 schematically illustrates a technical system 1, for example a vehicle or a robot, with a sensor 2, for example a camera sensor.

In particular, the disclosure aims to provide a method that enables technical systems, such as autonomous vehicles or robots, to iteratively improve their assumptions about an environment of the technical system by way of vision language models (VLMs). By verifying previously predicted assumptions, continuous learning can be enabled, and better decisions can be made.

Deficiencies in the prior art that are rectified by the method according to exemplary embodiments of the disclosure include, for example, a lack of mechanisms for online learning and continuous improvement during operation, insufficient use of unexpected or new situations to improve model performance, increasing generalization capability through an immanent adaptation mechanism that enables higher resiliency on the system side, as well as challenges in integrating large models into real-time systems due to limited computing resources.

According to exemplary embodiments, the disclosure comprises a multi-stage approach for improving assumptions in technical systems such as autonomous vehicles by employing vision language models (VLM). By comparing previous assumptions with actual events in real time, the technical system can iteratively learn and adjust its decision-making processes.

The method according to exemplary embodiments comprises a continuous comparison of predicted assumptions with actual events and an identification of discrepancies. Furthermore, the method according to exemplary embodiments of the disclosure comprises an iterative improvement of the assumptions. New, improved assumptions may be generated based on the identified discrepancies. According to the disclosure, vision language models of different sizes and complexity can be used to enable both fast response times and in-depth analysis.

Sensor and situational data for unforeseen events may also be provided and used for later offline analysis and retraining. For example, in the event of uncertainties over a longer period of time, the technical system may also slow down or stop to have more time to make decisions or to obtain support from more powerful vision language models via the Internet or via a human.

Continuous adjustment can improve how new or unexpected situations are managed. The staggered architecture of multiple vision language models enables efficient use of computational resources by leveraging smaller vision language models for quick decisions and larger vision language models for complex analyses. The ability to react appropriately when uncertain may further increase safety, for example, in road traffic or in a production hall. In addition to autonomous driving, the method is also transferable to other areas of robotics and intelligent systems.

According to exemplary embodiments of the disclosure, a first vision language model may be used for real-time decisions. This is performed in particular at a first frequency, for example 10 times per second. The first vision language model preferably makes assumptions about a next state of an environment of the technical system and may derive direct control actions therefrom. A control action may, depending on the system design, be a hardware-level control such as a steering or braking signal, or a more abstract command such as a target trajectory for middleware. The time horizons of the plans for control actions are in particular in a range of single-digit multiples of the time steps of the first vision language model, i.e., a 1-second plan horizon for a 10 Hz vision language model, e.g., a list of steering signals, or 10 seconds for a 1 Hz vision language model, e.g., a trajectory.

According to the disclosure, the assumptions made by the first vision language model are in particular (continuously) compared with actual events on the basis of further sensor data. The time horizon for predictions is preferably similar to the plan horizon. Discrepancies can be identified and analyzed as a result.

A second vision language model, which is preferably more powerful than the first vision language model, can enable iterative improvement. In particular, the second vision language model is run at a lower frequency (e.g., once per second) than the first vision language model. The second vision language model may use results from the first vision language model, the used sensor data, and the identified discrepancies to generate better assumptions. These better assumptions can now be provided to the first vision language model as support, for example as a prompt.

If a situation could not be correctly anticipated, i.e., if predicted assumptions are incorrect, the corresponding sensor data can be transferred to an external data processing device, for example, and used for future offline training processes.

Furthermore, it may be provided that if no or insufficient assumptions are made, the technical system may be set to a safe state; for example, the technical system could decelerate or stop. As a result, the second vision language model or an external data processing device, particularly a cloud-based system, may be given more time for analysis. Optionally, assistance may be requested from a human operator.

It is conceivable, according to exemplary embodiments of the disclosure, that further vision language model stages of different complexity may be added to increase adaptability.

Furthermore, data from at least one external data source may be integrated. For example, traffic information or map data may be used to support the decision-making processes.

The method according to the disclosure is also applicable, for example, to industrial robots, drones, or other intelligent systems.

The foregoing explanation of the exemplary embodiments describes the present disclosure exclusively in the context of examples. Of course, individual features of the embodiments may be freely combined with one another, if technically feasible, without leaving the scope of the present disclosure.

What is claimed is:

1. A method for predicting a control action for a technical system, comprising:
providing sensor data, wherein the sensor data results from an acquisition by at least one sensor of the technical system,
predicting at least one assumption regarding an environment of the technical system based on an analysis of the provided sensor data by way of a first vision language model,
providing further sensor data, wherein the further sensor data results from a further acquisition by the at least one sensor of the technical system,
verifying the at least one predicted assumption based on an analysis of the provided further sensor data,
wherein, in the event that a result of the verification indicates that the at least one predicted assumption is false, the following further steps are performed:
determining at least one new assumption regarding the environment of the technical system based on an analysis of the provided sensor data and/or the provided further sensor data and the result of the verification by way of a second vision language model, and
predicting the control action for the technical system using the at least one new assumption by way of the first vision language model.

2. The method according to claim 1, wherein the at least one assumption represents at least one visible and/or deducible condition regarding the environment including a structural characteristic, a positioning or movement of objects and/or a weather condition, and/or at least one visible and/or deducible condition regarding at least one person in the environment of the technical system including an intention or prospective movement of the at least one person.

3. The method according to claim 1, wherein the second vision language model is more powerful than the first vision language model, and wherein the second vision language model is executed at a lower frequency than the first vision language model.

4. The method according to claim 1, further comprising:
in the event that the result of the verification indicates that the at least one predicted assumption is false, initiating a transition of the technical system to a safe state.

5. The method according to claim 1, further comprising:
in the event that the result of the verification indicates that the at least one predicted assumption is false, providing training data based on the provided sensor data, the provided further sensor data, and the result of the verification.

6. The method according to claim 1, wherein in the event that, during the determination of the at least one new assumption, an error occurs or no new assumption can be determined, further comprising at least one of the following steps:
determining at least one new assumption regarding the environment of the technical system based on an analysis of the provided sensor data and/or the provided further sensor data and the result of the verification by way of a third vision language model, wherein the third vision language model is more powerful than the second vision language model,
initiating output of a notification to a human operator.

7. The method according to claim 1, further comprising:
providing data from at least one external data source, wherein the data comprises traffic information relating to the environment of the technical system and/or map data relating to the environment of the technical system,
wherein the prediction of the at least one assumption, the verification, and/or the determination is further performed based on the provided data from the at least one external data source.

8. A computer program comprising instructions which, when the computer program is executed by at least one computer, prompt the computer to execute the method according to claim 1.

9. A device for data processing, which is configured to carry out the method according to claim 1.

10. A computer-readable storage medium comprising instructions which, when executed by at least one computer, prompt the computer to perform the steps of the method according to claim 1.

11. The method according to claim 1, wherein the at least one assumption represents at least one visible and/or deducible condition regarding the environment, and/or at least one visible and/or deducible condition regarding at least one person in the environment of the technical system.

12. The method according to claim 1, further comprising:
in the event that the result of the verification indicates that the at least one predicted assumption is false, initiating a transition of the technical system to a safe state by way of a braking operation.

13. The method according to claim 1, further comprising:
in the event that the result of the verification indicates that the at least one predicted assumption is false, providing training data based on the provided sensor data, the provided further sensor data, the result of the verification, and the at least one new assumption.
